(19) United States
(12) Patent Application Publication
(10) Pub. No.: US 2006/0268886 A1
(43) Pub. Date: Nov. 30, 2006

(54) Wireless communication method and system for enhancing the capability of WLAN control frames

(75) Inventors: Mohammed Sammour, Montreal (CA); Arty Chandra, Manhasset Hills, NY (US); Sudheer A. Grandhi, Mamaroneck, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/413,328

(22) Filed: Apr. 28, 2006

Related U.S. Application Data
(60) Provisional application No. 60/677,768, filed on May 4, 2005.

(51) Int. Cl. H04L 12/56

(52) U.S. Cl. 370/394; 370/338

(57) ABSTRACT

A method and system for enhancing the capabilities of wireless local area network (WLAN) control frames in general, and particularly block acknowledgement (ACK) frames, such as block ACK request (BAR) frames and block ACK response (BA) frames are disclosed. Furthermore, the functionalities these frames provide are extended by indicating the types of such functionalities within the BAR or BA frame formats. This enables the BAR or BA frames to be used more flexibly and on an as-needed basis, without the restriction of simultaneously providing all functionalities. The BAR/BA setup and negotiation procedure is also modified to provide more flexibility. In another embodiment, request to send (RTS) frames or clear to send (CTS) frames are used for the purpose of granting reverse direction traffic, and may be aggregated with data frames.

### CROSS REFERENCE TO RELATED APPLICATION

This application claims the benefit of U.S. Provisional application No. 60/677,768 filed May 4, 2005, which is incorporated by reference as if fully set forth.

### FIELD OF INVENTION

The present invention generally relates to wireless local area networks (WLANs). More particularly, the present invention is related to a method and system for enhancing the capabilities of WLAN control frames to support multiple functionalities, and to provide support for reverse directional or bi-directional traffic flows.

### BACKGROUND

In an access point (AP)-based WLAN, multiple wireless transmit/receive units (WTRUs), (i.e., mobile stations (STAs)), may be associated to a given access point (AP) at a given time. If the multiple-access scheme is carrier sense multiple access/collision avoidance (CSMA/CA), such as in IEEE 802.11-based WLANs, any WTRU may transmit a packet, (also called a “frame”), to its associated AP or another WTRU at any given time. The receiving WTRU determines which WTRU has transmitted a packet, after the packet has been completely received within a Short Inter Frame Spacing (SIFS) and an acknowledgement (ACK) response has been sent to the transmitting WTRU by the receiving WTRU. The ACK response indicates that the last packet was received successfully based on a cyclic redundancy code (CRC) calculation.

In an IEEE 802.11e system, multiple packets may be sent before expecting a block ACK response from the receiving WTRU. A block ACK mechanism for WLAN systems is described in the IEEE 802.11e standard proposal. In the IEEE 802.11e standard proposal, there are two block ACK policies that can be used:
1) an immediate block ACK; and
2) a delayed block ACK.

A typical block ACK frame exchange sequence 100 using the immediate block ACK for a single traffic identifier (TID) is shown in FIG. 1.

A typical block ACK frame exchange sequence 200 using the delayed block ACK for a single TID is shown in FIG. 2.

As shown in FIGS. 1 and 2, a block ACK request (BAR) packet 105 is included in either of the immediate or delayed block ACK frame exchange sequences 100, 200 sent by an originator to a recipient. The BAR packet 105 indicates to the recipient that the recipient should construct and send a block ACK response (BA) packet 110 back to the originator. The BA 110 specifies which data packets were correctly received by the recipient. The ACK 115 is a normal acknowledgement packet which confirms that the BAR 105 or the BA 110 had been received, depending on the context. The terminology “[sifs]” represents the short inter-frame spacing 120, which is an idle time specified by the IEEE 802.11 standard.

Currently, proposals are being presented and discussed for the IEEE 802.11n extension to the 802.11 WLAN standard, which will allow for higher throughput WLAN devices. There were some suggestions made within the TGnSync group for the possible use of BAR and/or BA packets for other functions within the 802.11n standard proposal, such as link adaptation, (e.g., providing transmission mode feedback (i.e., modulation and coding scheme (MCS) feedback)), or a reverse direction traffic grant. In order to support such new functions within the BAR or BA packets, additional enhancements would be required in order to ensure the proper functioning and interpretation of such packets.

Another area is related to reverse direction traffic or bi-directional traffic flow feature. The TGnSync proposal, (document number IEEE 802.11-04/0889r44), describes a mechanism for a reverse direction data protocol, (as well as bi-directional traffic flow), whereby a recipient is granted the opportunity to send data to the originator within a transmission opportunity (TXOP). Initiator aggregate control (IAC)/responder aggregate control (RAC) frames with reverse direction limit (RDL), reverse direction grant (RDG) or reverse direction request (RDR) messages are used to achieve such reverse direction traffic or bi-directional traffic functionality. There were also proposals to use the BAR/BA packets for such functionality, or use a quality of service (QoS) contention free (CF)-poll instead of IAC/RAC.

It would be desirable to use request to send (RTS) or clear to send (CTS) frames for the purpose of provide support for reverse direction or bi-directional traffic flows.

### SUMMARY

The present invention is related to a method and system for enhancing the capabilities of WLAN control frames in general, and particularly block acknowledgement (ACK) frames, such as BAR frames and BA frames. Furthermore, the functionalities these frames provide are extended by indicating the types of such functionalities within the BAR or BA frame formats. This enables the BAR or BA frames to be used more flexibly and on an as-needed basis, without the restriction of simultaneously providing all functionalities. The BAR/BA setup and negotiation procedure is also modified to provide more flexibility. In another embodiment, RTS frames or CTS frames are used for the purpose of granting reverse direction traffic, and may be aggregated with data frames.

### BRIEF DESCRIPTION OF THE DRAWINGS

A more detailed understanding of the invention may be illustrated from the following description of a preferred embodiment, given by way of example and to be understood in conjunction with the accompanying drawing wherein:

FIG. 1 shows a conventional block ACK frame exchange sequence using the immediate block ACK;

FIG. 2 shows a conventional block ACK frame exchange sequence using the delayed block ACK;

FIGS. 3 and 4 show frame exchange sequences in which a field type is used to indicate the type of information that is available or valid in accordance with the present invention;

FIG. 5 shows a frame exchange sequence in which a validity field or bit (V) is used to indicate if certain information is available or valid in accordance with the present invention;

FIG. 6 shows a frame exchange sequence in which availability or validity information is implicitly derived from the contents of each information field in accordance with the present invention;

FIG. 7 shows a block ACK enhancement which includes link adaptation (MCS feedback) and a reverse direction grant in accordance with the present invention; and

FIG. 8 shows an exemplary wireless communication system in which two WTRUs exchange frame sequences in accordance with the present invention.

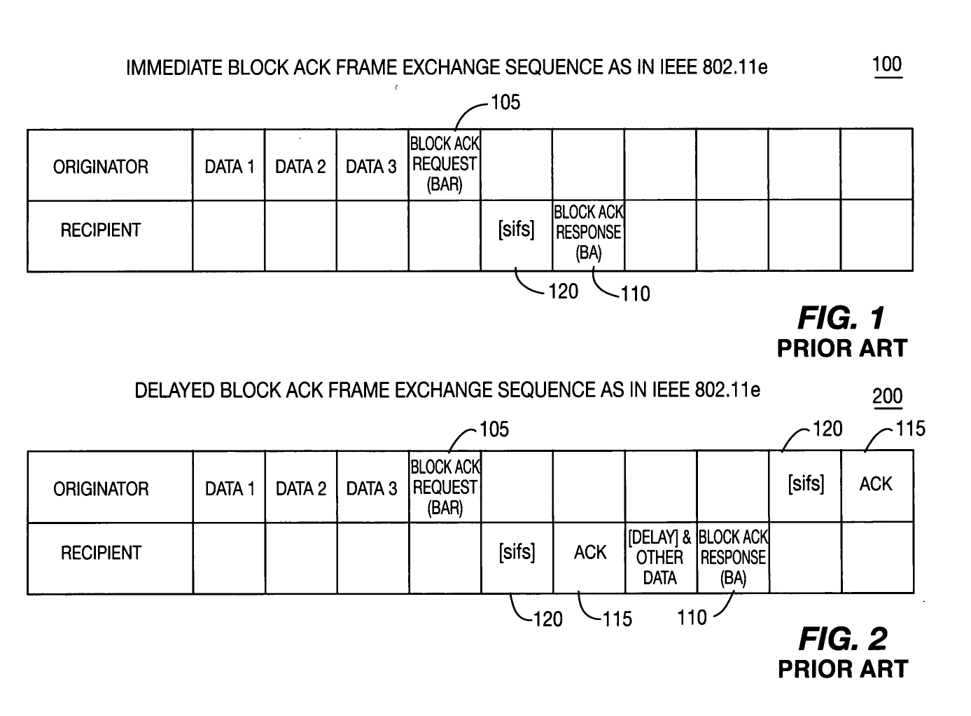

### DETAILED DESCRIPTION OF THE PREFERRED EMBODIMENTS

When referred to hereafter, the terminology “WTRU” includes but is not limited to a user equipment (UE), a mobile station, a fixed or mobile subscriber unit, a pager, or any other type of device capable of operating in a wireless environment.

The features of the present invention may be incorporated into an integrated circuit (IC) or be configured in a circuit comprising a multitude of interconnecting components.

Since various types of information may be included within the block ACK packets, (i.e., BAR and/or BA), the present invention provides a method for identifying the presence and/or validity of the different types of information that may be contained within the associated block ACK packets. The method includes a field/bit in the block ACK packets to identify the presence of a given type of information. When a WTRU receives this field/bit, the WTRU knows that a particular type of information is present. For example, BAR/BA frames may contain link adaptation information, (e.g., MCS request/feedback), and may contain reverse direction traffic information, (e.g., RDR/RDG), in addition to the original block ACK information, (e.g., request and response).

The present invention uses a link adaptation term to refer to any of the following: MCS feedback, channel training request, channel measurement response, and any other procedure for wireless link adaptation. Since not all such types of information may need to be present simultaneously within the new BAR/BA frames, the present invention provides a method for identifying what type(s) of information are present within the BAR/BA frames, and also where, within the BAR/BA frames, such information is present. The present invention includes a “type” field within the BAR/BA frame header or frame body. For example, a “type” field is included within the BAR or BA control field.

To illustrate, the BA packet may be used to provide link adaptation feedback in response to a BAR packet, (instead of using IAC/RAC). Furthermore, the BAR and BA may be used to achieve the functionality of reverse direction traffic request and grant (RDR/RDG). In order to add flexibility to the BAR/BA frames, the present invention adds a field to the BAR packet, (preferably a bitmap in the header control part), to indicate whether the BAR packet is also requesting link adaptation information to be sent in the BA, and/or is providing reverse traffic direction information, and/or is requesting a block acknowledgement to confirm which frames have been received correctly by the destination station.

The present invention uses a type field to indicate what the BAR packet really means, and what valid information it contains, e.g., whether it contains a BAR-only, a BAR+RDG+MCS request, or any possible combination of these 3 different functionalities. The corresponding block ACK response within the “granted” reverse direction transmission would contain a BA+MCS feedback (MFB).

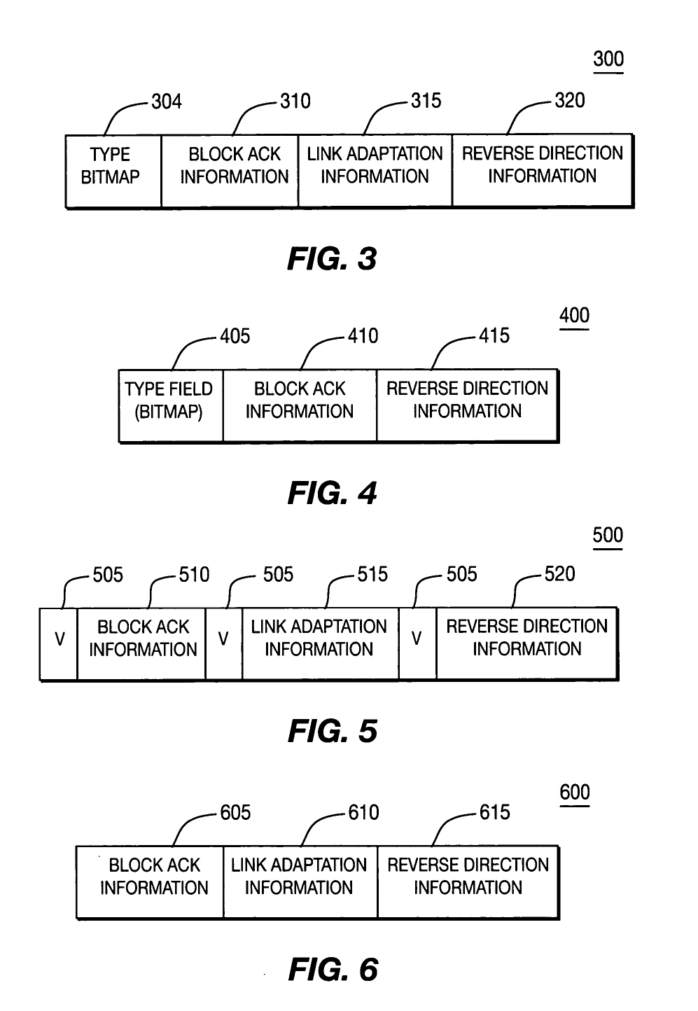

FIG. 3 shows a frame exchange sequence 300 in which a type field, (e.g., a type bitmap), is incorporated within the frame, (e.g., within the BAR or BA frame) in accordance with the present invention. The frame exchange sequence 300 includes a type bitmap field 305, a block ACK information field 310, a link adaptation information field 315 and a reverse direction information field 320.

FIG. 4 shows a frame exchange sequence 400 in which a type field 405, (e.g., bitmap), is incorporated within the frame, (e.g., within the BAR or BA frame), in accordance with the present invention. The type field 405 indicates that only a block ACK information field 410 and a reverse direction information field 415 are available or valid, while a link adaptation information field is not available.

FIG. 5 shows a frame exchange sequence 500 in which a validity field or bit (V) 505 is used to indicate if certain information is available or valid, such as in a block ACK information field 510, a link adaptation information field 515 and a reverse direction information field 520 in accordance with the present invention.

FIG. 6 shows a frame exchange sequence 600 in accordance with the present invention, where the availability or validity of the different types of information within the frame, such as in a block ACK information field 605, a link adaptation information field 610 and a reverse direction information field 615, is implicitly derived from the contents of each information field, rather than explicitly communicated via a type field or a validity field.

In accordance with the present invention, BA frames may be sent in an unsolicited manner, in order to increase the flexibility and capability of such frames. Such unsolicited BA can be useful for providing channel measurement information within the BA, and sending the BA without the need for a BAR to trigger it.

In another embodiment of the present invention, the BA negotiation/setup phase (e.g. ADDBA/DELBA) is modified in such a way that will make the outcome of the BA negotiation/setup procedure specify whether the two WTRUs, (e.g., an AP and a WTRU), are capable of and would like to run, (engage in), in any one of the following:
1) a block ACK scheme only;
2) a reverse direction traffic scheme only;
3) a block ACK scheme and a reverse direction traffic scheme; and
4) none of the above schemes.

Additionally, a reverse direction limit (RDL) field (or packet) that is analogous to RDL in RDR/RDG messages, is included/communicated in the BA negotiation/setup phase. The present invention modifies the BA negotiation/setup phase, (e.g., add BA (ADDBA)/delete BA (DELBA)) in such a way that will make the outcome of the BA negotiation/setup procedure specify whether the two WTRUs, (e.g., an AP and an WTRU), are capable of and would like to run (engage in) in any one of the following:
1) a block ACK scheme only;
2) a link adaptation scheme only, (e.g., MCS request/feedback and sounding);
3) a block ACK scheme and link adaptation scheme; and
4) none of the above schemes.

Furthermore, the BA negotiation/setup phase, (e.g., ADDBA/DELBA), may be modified in such a way that will make the outcome of the BA negotiation/setup procedure specify whether the two WTRUs, (e.g., an AP and a WTRU), are capable of and would like to run (engage in) in any of the following:
1) a block ACK scheme only;
2) a reverse direction traffic scheme only;
3) a link adaptation scheme only, (e.g., MCS request/feedback and sounding);
4) a block ACK scheme and a reverse direction traffic scheme;
5) a block ACK scheme and a link adaptation scheme;
6) a block ACK scheme, a reverse direction traffic scheme and a link adaptation scheme; and
7) none of the schemes.

Although the functionality was described above using the case of BAR and BA frames, it is important to realize that this invention is equally applicable to all control frames. The present invention may also be applicable to management frames, action frames and/or data frames.

In another embodiment of the present invention, an RTS frame or a CTS frame is used for the purpose of requesting or granting reverse directional traffic, (e.g., bi-directional traffic flow), or any modified (enhanced) version of such RTS or CTS frames.

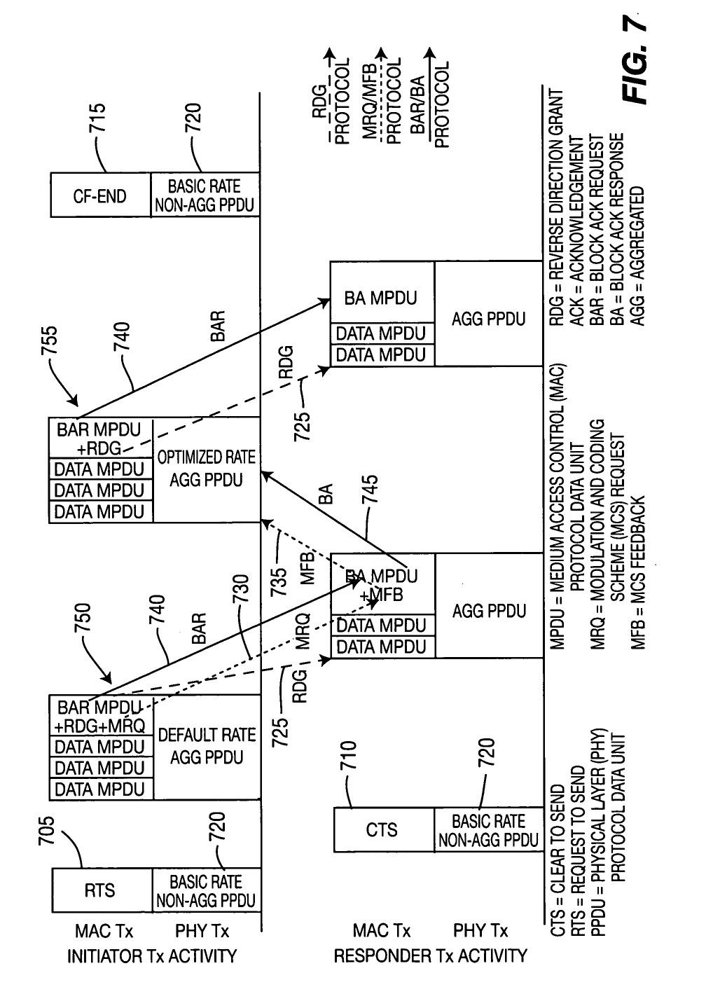

FIG. 7 shows a block ACK enhancement which includes link adaptation (MCS feedback) and a reverse direction grant in accordance with the present invention in which an initiator exchanges frame sequences with a responder. The initiator sends an RTS frame 705 and the responder sends a CTS frame 710. After the exchange of frame sequences is completed, the initiator sends a contention free-end (CF-END) frame 715. Each of the RTS 705, CTS 710 and CF-END frames 715 are sent from a MAC layer to a physical layer (PHY) as basic rate non-aggregated PHY protocol data units (PPDUs) 720. When the initiator sends an RDG 725 to the responder, a reverse direction transmission from the responder results. When the initiator sends an MRQ 730 to the responder, the responder replies with MFB 735. When the initiator sends a BAR 740 to the responder, the responder sends a BA 745 to the initiator.

Data MPDUs are aggregated as one large packet 750 and sent from the MAC layer to the PHY for transmission to the responder at a default rate. Once MFB 735 is received by the initiator, additional MPDUs are aggregated as one large packet 755 and sent from the MAC layer to the PHY of the initiator for transmission to the responder at an optimized rate by adjusting MCS parameters in accordance with the MFB 735. The aggregation of the MPDUs provides efficiency since there is no inter frame spacing between the individual MPDUs. The aggregated MPDUs share a single PHY header, thus reducing overhead. The non-aggregated PPDUs 720 carry non-aggregated or single packets.

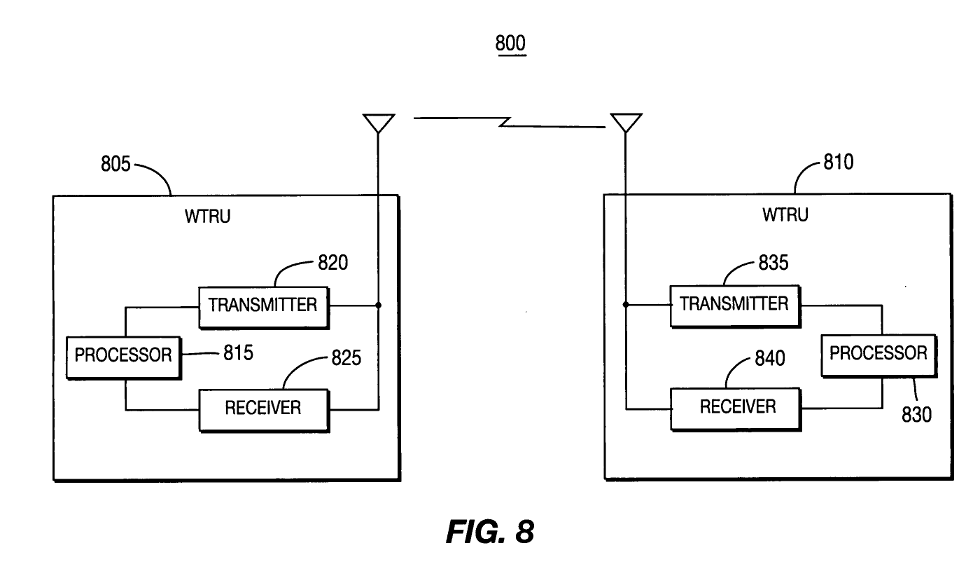

FIG. 8 shows an exemplary wireless communication system 800 in which a first WTRU 805, (i.e., the initiator), and a second WTRU 810, (i.e., the responder), exchange frame sequences in accordance with the present invention. The WTRU 805 includes a processor 815, a transmitter 820 and a receiver 825. The WTRU 810 includes a processor 830, a transmitter 835 and a receiver 840.

Referring to FIGS. 7 and 8, the WTRU 805 sends traffic to the WTRU 810. The WTRU 805 may grant the WTRU 810 the opportunity of sending reverse direction traffic using either an RTS frame 705 or a CTS frame 710, or an enhanced version of any of those frames. If the processor 830 in the WTRU 810 decides to take the opportunity to send its data based on a grant received by the receiver 840 in the WTRU 810, then the transmitter 835 in the WTRU 810 will start sending traffic in the reverse direction for a certain, (e.g., specified), time period. This time period is determined by the initiator/grantor of the reverse direction grant (RDG), (i.e., WTRU 805), based on available time within its TXOP and the traffic load of the reverse transmission, which is indicated earlier by the responder station through feedback via a QoS control field already existing in data packets. This time period may be communicated using the duration/ID field of the RTS or CTS MAC header 705, 710.

If the WTRU 810 does not have data to send in the reverse direction, then the WTRU 810 may decline or indicate to the WTRU 805 that it will not send data traffic in the reverse direction, by the WTRU 810 sending a frame such as, for example, a CF-END frame 715 or any other frame, (e.g., any control frame). Also, it is possible to have the WTRU 810 make a request for reverse direction traffic to the WTRU 805, via the use of either an RTS frame 705 or a CTS frame 710, or an enhanced version of any of those frames.

Note that the CTS frame 710, (or an enhanced version of it), may be sent in an unsolicited manner, and the CTS frame 710 does not have to be restricted to being only sent in response to the RTS frame 705. For example, the transmitter 820 in the WTRU 805 may send a CTS frame 710 to grant reverse direction traffic to the WTRU 810, without having the WTRU 810 send an RTS frame 705 to the WTRU 805. Also a CTS frame 710 or an RTS frame 705 can be aggregated with data frames 720, or with any other frames.

Although the features and elements of the present invention are described in the preferred embodiments in particular combinations, each feature or element can be used alone (without the other features and elements of the preferred embodiments) or in various combinations with or without other features and elements of the present invention.

What is claimed is:

1. In a wireless communication system including a plurality of wireless transmit/receive units (WTRU), a method comprising:
(a) a first one of the WTRUs transmitting a block acknowledgement (ACK) request (BAR) packet which includes a field that identifies whether the BAR packet is also requesting link adaptation information to be included in a block ACK packet sent in response to receiving the BAR packet; and
(b) a second one of the WTRUs receiving the BAR packet and generating a block ACK packet in accordance with the link adaptation information in the BAR packet.

2. The method of claim 1 wherein the link adaptation information includes modulation and coding scheme feedback information.

3. The method of claim 1 wherein the link adaptation information includes channel training request information.

4. The method of claim 1 wherein the link adaptation information includes channel measurement response information.

5. In a wireless communication system including a plurality of wireless transmit/receive units (WTRU), a method comprising:
(a) a first one of the WTRUs transmitting a message frame which includes a type field, a block acknowledgement (ACK) information field, a link adaptation information field and a reverse direction information field; and
(b) a second one of the WTRUs receiving the message frame and generating a response frame in accordance with the fields in the message frame.

6. In a wireless communication system including a plurality of wireless transmit/receive units (WTRU), a method comprising:
(a) a first one of the WTRUs transmitting a message frame which includes a block acknowledgement (ACK) information field, a link adaptation information field and a reverse direction information field; and
(b) a second one of the WTRUs receiving the message frame and generating a response frame in accordance with the fields in the message frame.

7. The method of claim 6 wherein the message frame further includes a validity field or bit associated with the block ACK information field which indicates whether information in the block ACK information field is available or valid.

8. The method of claim 6 wherein the message frame further includes a validity field or bit associated with the link adaptation information field which indicates whether information in the link adaptation field is available or valid.

9. The method of claim 6 wherein the message frame further includes a validity field or bit associated with the reverse direction information field which indicates whether information in the reverse direction information field is available or valid.

10. In a wireless communication system including a plurality of wireless transmit/receive units (WTRU), a method comprising:
(a) a first one of the WTRUs transmitting a message frame which includes a type field, a link adaptation information field, a block acknowledgement (ACK) information field and a reverse direction information field, wherein the type field indicates that the block ACK information and the reverse direction field are valid or available, while the link adaptation field is not valid available or valid; and
(b) a second one of the WTRUs receiving the message frame and generating a response frame in accordance with the fields in the message frame.

11. In a wireless communication system including a plurality of wireless transmit/receive units (WTRU), a method comprising:
(a) a first one of the WTRUs transmitting a message frame which includes a type field and at least one information field, wherein the type field indicates whether the at least one information field is valid or available; and
(b) a second one of the WTRUs receiving the message frame and generating a response frame in accordance with the fields in the message frame.

12. In a wireless communication system including a plurality of wireless transmit/receive units (WTRU), a method comprising:
one of the WTRUs transmitting a message frame which includes a type field and a plurality of information fields, wherein the type field indicates which of the information fields are valid or available, and which of the information fields are not valid or available.

13. The method of claim 12 wherein the message frame is block acknowledgement (ACK) request frame.

14. The method of claim 12 wherein the message frame is block acknowledgement (ACK) response frame.

15. The method of claim 12 wherein the type field is encoded as a bit map.

16. The method of claim 12 wherein the message frame is a clear to send (CTS) message frame.

17. The method of claim 12 wherein the message frame is a request to send (RTS) message frame.

18. A wireless communication system comprising:
(a) a first wireless transmit/receive unit (WTRU) which transmits a block acknowledgement (ACK) request (BAR) packet which includes a field that identifies whether the BAR packet is also requesting link adaptation information to be included in a block ACK packet sent in response to receiving the BAR packet; and
(b) a second WTRU which receives the BAR packet and generating a block ACK packet in accordance with the link adaptation information in the BAR packet.

19. The system of claim 18 wherein the link adaptation information includes modulation and coding scheme feedback information.

20. The system of claim 18 wherein the link adaptation information includes channel training request information.

21. The system of claim 18 wherein the link adaptation information includes channel measurement response information.

22. A wireless communication system comprising:
(a) a first wireless transmit/receive unit (WTRU) which transmits a message frame which includes a type field, a block acknowledgement (ACK) information field, a link adaptation information field and a reverse direction information field; and
(b) a second WTRU which receives the message frame and generates a response frame in accordance with the fields in the message frame.

23. A wireless communication system comprising:
(a) a first wireless transmit/receive unit (WTRU) which transmits a message frame which includes a block acknowledgement (ACK) information field, a link adaptation information field and a reverse direction information field; and
(b) a second WTRU which receives the message frame and generates a response frame in accordance with the fields in the message frame.

24. The system of claim 23 wherein the message frame further includes a validity field or bit associated with the block ACK information field which indicates whether information in the block ACK information field is available or valid.

25. The system of claim 23 wherein the message frame further includes a validity field or bit associated with the link adaptation information field which indicates whether information in the link adaptation field is available or valid.

26. The system of claim 23 wherein the message frame further includes a validity field or bit associated with the reverse direction information field which indicates whether information in the reverse direction information field is available or valid.

27. A wireless communication system comprising:
(a) a first wireless transmit/receive unit (WTRU) which transmits a message frame which includes a type field, a link adaptation information field, a block acknowledgement (ACK) information field and a reverse direction information field, wherein the type field indicates that the block ACK information and the reverse direction field are valid or available, while the link adaptation field is not valid available or valid; and
(b) a second WTRU which receives the message frame and generates a response frame in accordance with the fields in the message frame.

28. A wireless communication system comprising:
(a) a first wireless transmit/receive unit (WTRU) which transmits a message frame which includes a type field and at least one information field, wherein the type field indicates whether the at least one information field is valid or available; and
(b) a second WTRU which receives the message frame and generates a response frame in accordance with the fields in the message frame.

29. A wireless transmit/receive unit (WTRU) comprising:
a processor which generates a message frame which includes a type field and a plurality of information fields, wherein the type field indicates which of the information fields are valid or available, and which of the information fields are not valid or available; and
a transmitter coupled to the processor for transmitting the message frame.

30. The WTRU of claim 29 wherein the message frame is block acknowledgement (ACK) request frame.

31. The WTRU of claim 29 wherein the message frame is block acknowledgement (ACK) response frame.

32. The WTRU of claim 29 wherein the type field is encoded as a bit map.

33. The WTRU of claim 29 wherein the message frame is a clear to send (CTS) message frame.

34. The WTRU of claim 29 wherein the message frame is a request to send (RTS) message frame.

35. An integrated circuit (IC) comprising:
a processor which generates a message frame which includes a type field and a plurality of information fields, wherein the type field indicates which of the information fields are valid or available, and which of the information fields are not valid or available; and
a transmitter coupled to the processor for transmitting the message frame.

36. The IC of claim 35 wherein the message frame is block acknowledgement (ACK) request frame.

37. The IC of claim 35 wherein the message frame is block acknowledgement (ACK) response frame.

38. The IC of claim 35 wherein the type field is encoded as a bit map.

39. The IC of claim 35 wherein the message frame is a clear to send (CTS) message frame.

40. The IC of claim 35 wherein the message frame is a request to send (RTS) message frame.

41. A wireless transmit/receive unit (WTRU) comprising:
a processor configured to generate a request to send (RTS) frame including a reverse direction grant (RDG) field; and
a transmitter coupled to the processor, the transmitter being configured to transmit the RTS frame to another WTRU that has data to send in a reverse direction.

42. The initiating WTRU of claim 41 wherein the RTS frame is aggregated with a plurality of data frames.

43. A wireless transmit/receive unit (WTRU) comprising:
a processor configured to generate a clear to send (CTS) frame including a reverse direction grant (RDG) field; and
a transmitter coupled to the processor, the transmitter being configured to transmit the CTS frame to another WTRU that has data to send in a reverse direction.

44. The WTRU of claim 43 wherein the CTS frame is aggregated with a plurality of data frames.

45. An integrated circuit (IC) embedded in an initiating wireless transmit/receive unit (WTRU), the IC comprising:
a processor configured to generate a request to send (RTS) frame including a reverse direction grant (RDG) field; and
a transmitter coupled to the processor, the transmitter being configured to transmit the RTS frame to a responding WTRU.

46. The IC of claim 45 wherein the RTS frame is aggregated with a plurality of data frames.

47. An integrated circuit (IC) embedded in a responding wireless transmit/receive unit (WTRU), the IC comprising:
a processor configured to generate a clear to send (CTS) frame including a reverse direction grant (RDG) field; and
a transmitter coupled to the processor, the transmitter being configured to transmit the CTS frame to an initiating WTRU.

48. The IC of claim 47 wherein the CTS frame is aggregated with a plurality of data frames.

49. In a wireless communication system including an initiator and a responder, a method comprising:
(a) the initiator transmitting to the responder at a default rate an aggregated physical layer protocol data unit (PPDU) which includes a plurality of data medium access control (MAC) protocol data units (MPDUs) and an enhanced block acknowledgement request (BAR) MPDU having a reverse direction grant (RDG) field and a modulation and coding scheme (MCS) request field; and
(b) the responder transmitting to the initiator an aggregated PPDU which includes a plurality of data MPDUs and an enhanced block acknowledgement response (BA) MPDU having an MCS feedback (MFB) field.

50. The method of claim 49 further comprising:
(c) the initiator sending at least one additional aggregated PPDU at a rate optimized in accordance with parameter values specified by the MFB field.

51. The method of claim 49 further comprising:
(c) the initiator sending to the responder a request to send (RTS) packet as a basic rate non-aggregated PPDU;
(d) the responder sending to the initiator a clear to send (CTS) packet as a basic rate non-aggregated PPDU; and
(e) after the exchange of frame sequences between the initiator and the responder is completed, the initiator sending a contention free-end (CF-END) packet as a basic rate non-aggregated PPDU.

52. A wireless transmit/receive unit (WTRU) comprising:
(a) a processor for generating an aggregated physical layer protocol data unit (PPDU) which includes a plurality of data medium access control (MAC) protocol data units (MPDUs) and a block acknowledgement request (BAR) MPDU having a reverse direction grant (RDG) field and a modulation and coding scheme (MCS) request field; and
(b) a transmitter coupled to the processor for transmitting the aggregated PPDU at a default rate.

53. A wireless transmit/receive unit (WTRU) comprising:
(a) a receiver for receiving a block acknowledgement response (BA) medium access control (MAC) protocol data unit (MPDU) having a modulation and coding scheme (MCS) feedback field;
(b) a processor coupled to the receiver for generating an aggregated physical layer protocol data unit (PPDU) which includes a plurality of data MPDUs and a block acknowledgement request (BAR) MPDU having a reverse direction grant (RDG) field; and
(c) a transmitter coupled to the processor for transmitting the aggregated PPDU at a rate optimized in accordance with parameter values specified by the MFB field.

54. An integrated circuit (IC) comprising:
(a) a receiver for receiving a block acknowledgement response (BA) medium access control (MAC) protocol data unit (MPDU) having a modulation and coding scheme (MCS) feedback field;
(b) a processor coupled to the receiver for generating an aggregated physical layer protocol data unit (PPDU) which includes a plurality of data MPDUs and a block acknowledgement request (BAR) MPDU having a reverse direction grant (RDG) field; and
(c) a transmitter coupled to the processor for transmitting the aggregated PPDU at a rate optimized in accordance with parameter values specified by the MFB field.

55. A wireless communication method comprising:
aggregating a request to send (RTS) frame with another frame;
an initiator transmitting the aggregated frames;
a responder receiving the aggregated frames;
the responder interpreting the aggregated frames as a reverse direction grant (RDG); and
the responder transmitting data in a reverse direction when aggregated frames are received and interpreted as being an RDG.

56. A wireless communication method comprising:
aggregating a clear to send (CTS) frame with another frame;
an initiator transmitting the aggregated frames;
a responder receiving the aggregated frames;
the responder interpreting the aggregated frames as a reverse direction grant (RDG); and
the responder transmitting data to the initiator in a reverse direction when aggregated frames are received and interpreted as being the RDG.

57. A wireless communication method comprising:
an initiator transmitting a request to send (RTS) frame;
a responder receiving the RTS frame;
the responder interpreting the RTS frame as a reverse direction grant (RDG); and
the responder transmitting data in a reverse direction when an RTS frame is received and interpreted as being an RDG.

58. A wireless communication method comprising:
an initiator transmitting a clear to send (CTS) frame;
a responder receiving the CTS frame;
the responder interpreting the CTS frame as being a reverse direction grant (RDG); and
the responder transmitting data in a reverse direction when a CTS frame is received and interpreted as being an RDG.
